(19) United States
(12) Patent Application Publication
(10) Pub. No.: US 2021/0259396 A1
(43) Pub. Date: Aug. 26, 2021

(54) SELF-ILLUMINATING WEARABLE WITH COMMUNICATION AND GUIDANCE SYSTEM

(71) Applicant: Trechrein LLC, St Louis, MO (US)

(72) Inventor: Antonio J. Gates, st. Louis, MO (US)

(73) Assignee: Trechrein LLC, St. louis, MO (US)

(21) Appl. No.: 17/183,563

(22) Filed: Feb. 24, 2021

Related U.S. Application Data
(63) Continuation-in-part of application No. 16/935,067, filed on Jul. 21, 2020, now abandoned.
Application No. 16/935,067 is a continuation-in-part of application No. 17/123,113, filed on Dec. 16, 2020.
(60) Provisional application No. 62/980,830, filed on Feb. 24, 2020.

(51) Int. Cl. A45F 3/14; G08B 5/38; A41D 1/00; A01K 27/00

(52) U.S. Cl. CPC A45F 3/14; G08B 5/38; A45F 2003/003; A01K 27/006; A41D 1/002

(57) ABSTRACT

There are no wearable communication and guidance systems, methods, and devices that facilitate integration and communication between devices for humans. This invention provides a wearable and non-wearable with communication and guidance integration system, method, and devices for humans. The present disclosure relates to a communication and guidance system wherein multiple devices are integrated and linked for faster, efficient, enhanced security, and unique systems, apparatus, and methods thereof. The wearable can be self-illumination wearables.

### STATEMENT REGARDING FEDERALLY SPONSORED RESEARCH OR DEVELOPMENT

This application is a Non-Provisional Application claiming priority of the Provisional U.S. Application Number 62/980,830 filed on Feb. 24, 2020, and is incorporated in entirety herein. This application is a continuation-in-part of the non-provisional application number application is a continuation of the U.S. application Ser. Nos. 16/935,067 and 17/123,113, which are incorporated in entirety herein by references.

### CROSS-REFERENCE TO RELATED APPLICATIONS:

None.

The present disclosure relates to a communication and guidance system wherein multiple devices are integrated and linked for faster, efficient, and unique systems, apparatus, and methods thereof.

### BACKGROUND

There are no wearable communication and guidance systems, methods, and devices that facilitate integration and communication between devices for humans. This invention provides a wearable with a communication and guidance integration system, method, and devices for humans.

### BRIEF DESCRIPTION OF THE INVENTION

This application relates to a unique and novel system, apparatus, and method for self-illumination wearable such as harness, vest, jacket, pants, etc. Moreover, the wearable may provide communication between humans for enhanced security such as police, emergency personnel, hunters, sports-people, runners, hikers, bikers, walkers, people in remote areas, people in the wilderness, land, sea, air, etc. The system may further provide a guidance system wherein humans may be guided remotely by team-lead, healthcare provider, satellite communication or GPS, and like and vice versa. These communication and guidance systems, methods, and apparatus may be achievable using one or more human senses such as vision, touch, voice, smell, and taste. The communication and guidance may be uni-, bi-, multiple directional, or any combination thereof. Furthermore, the communication and guidance system of this invention may use wearable and/or non-wearable apparatus and devices. The wearables and non-wearables may be smart, incorporated with electrical, electronics, microelectronics, nanoelectronics, internet of things, computer systems, Bluetooth, others, and/or any combination thereof.

They may communicate wired, wireless, or both. The wearables and non-wearables may communicate via touch-sensitive technologies, voice command technologies, integrated smartphones, wired or wireless remote control. They may be weather-, water-, temperature-, humidity-resistance or -proof, or any combination thereof. The batteries may be recharged via a variety of modes such as wired, wireless, solar, or any combination thereof.

### BRIEF DESCRIPTION OF DRAWINGS

FIG. 1: An example of an animal self-illuminating wearable device.

FIG. 2: An example of an animal self-illuminating wearable device.

FIG. 3: An example of an animal self-illuminating wearable device worn by a dog.

FIG. 4: An example of the self-illuminating wearable device for humans.

FIG. 5: An example of the self-illuminating wearable device for humans worn by a male.

FIGS. 6-10: An example of the self-illuminating wearable device communication with other users and non-users.

FIG. 11: Integration of wearables, non-wearables for human and non-human animal users.

### DETAILED DESCRIPTION OF THE INVENTION

Examples embodiments are provided so that this disclosure will be thorough and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The preceding summary, as well as the following detailed description of certain embodiments, will be better understood when read in conjunction with the appended figure of experimental data and results. As used herein, an element or step recited in the singular and proceeded with the word “a” or “an” should be understood as not excluding the plural of said elements or steps, unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition provided herein, it supersedes any other meaning or definition.

As used herein, the term “wearable” means harness, vest, jacket, pants, outerwear, etc., that which can be attached on to or worn by a human.

As used herein, the term “self-illuminating” means that it has the capability to provide illumination or light.

As used herein, the term “communication” means the exchange of information between two entities; herein, the entities are humans and non-human animals. Information can be exchanged between humans and humans and/or animals.

As used herein, the term “guidance” means escort or show the way to the other.

As used herein, the term “device” means an apparatus.

As used herein, the term “animals” means non-human vertebrate animals.

As used herein, the term “non-wearable” means that which cannot be worn by a human or an animal.

As used herein, the term “setting” or “mode” means a place or locus where something is placed for a pre-set event to take place.

As used herein, the term “technology” means apparatus, devices, smart devices electrical equipment, microelectronics, electronics, computer, hardware, software, instruments, machinery, and equipment.

As used herein, the term “strip” means a linear material.

As used herein, the term “streak” means a linear material with a width smaller than the aforementioned strip.

The self-illuminable wearable may be used by two or more users for communication and/or guidance.

In an embodiment of the invention, there may be two or more users such as 2, 3, 4, 5, 6, 7, 8, 9, 10, 11, 12, 13, 14, 15, 16, 17, 18, 19, 20, 21, 22, 23, 24, 25, 30, 35, 40, 45, 50, or more users and/or any combination thereof.

In an embodiment of the invention, the users may be humans, animals (including pets dogs, pet cats, hunting animals, zoo animals, etc.), and/or both.

In an embodiment of the invention, the human or animal torso may be part of the human or animal body between shoulders and start of the legs; in the backside, it may include part of the hips. Suppose the backside and the anterior side of the human or animal torso are divided into five equal parts separately. In that case, the results may be ten parts, with each part representing 10% of the total human or animal torso.

In an embodiment of the invention, the self-illuminable wearable may cover the backside, anterior, or both.

In an embodiment of the invention, the self-illuminable wearable may cover 2.5, 5, 7.5, 10, 15, 20, 25, 30, 35, 40, 45, 50, 55, 60, 65, 70, 75, 80, 85, 90, 95, 99 percent, or any combination thereof.

In an embodiment of the invention, the self-illuminable wearable may cover at least 2.5, 5, 7.5, 10, 15, 20, 25, 30, 35, 40, 45, 50, 55, 60, 65, 70, 75, 80, 85, 90, 95, 99 percent, or any combination thereof.

In an embodiment of the invention, the self-illuminating wearable may have 360 degrees of illumination such that no shadow is noticed.

In an embodiment of the invention, the wearable illumination may be visible from 1 to 10 miles aerially and/or without obstacles and obstructions.

In an embodiment of the invention, the illuminating wearable may include a dimmer switch with one, two, three, four, five, six, seven, eight, nine, ten, eleven, twelve, thirteen, fourteen, fifteen, etc., and/or any combination thereof different lighting levels and/or brightness.

In an embodiment of the invention, the illuminating wearable may have up to 2, 3, 4, 5, 6, 7, 8, 9, 10, 11, 12, 13, 14, 15, 20, etc., and/or any combination thereof different strobes settings.

In an embodiment of the invention, the LED strips on the illuminating wearable may comprise up to 10,000, 20,000, 30,000, 40,000, 50,000, 60,000, 70,000, 80,000, 90,000, 100,000, etc., and/or any combination thereof hours of battery life.

In an embodiment of the invention, the illuminating wearable may comprise sensors for measuring vitals that is linked to an app/APP. The app/APP may turn ON/OFF vital sensors, and APP/apps may receive and read vital information from one or more sensors.

In an embodiment of the invention, the light/illumination location, pattern, strobing, etc., on wearables and/or non-wearables may function as signals for a turn, stop, slowing, accelerating, etc., via wireless, Bluetooth remote, etc. and any combination thereof.

In an embodiment of the invention, interchangeable activity T-clip accessories may be included.

In an embodiment of the invention, the energy source may be a battery and/or an energy harvesting device, wherein the energy source may be solar, mechanical from movement or motion, user's body heat, etc., and/or any combination thereof.

In an embodiment of the invention, the wearable may comprise 3s lithium-ion batteries, which may be strategically hidden inside the wearable located below the user's neck to balance weight.

In an embodiment of the invention, the wearable may comprise strobing with a run time of 5-20, 5-18, 5-17, 5-16, 5-15, 5-14, 6-20, 6-18, 6-17, 6-16, 6-15, 6-14, 7-20, 7-18, 7-17, 7-16, 7-15, 7-14, 8-20, 8-18, 1-17, 8-16, 8-15, 8-14, 9-20, 9-18, 9-17, 9-16, 9-15, 9-14, etc., and/or any combination thereof of hours for light.

In an embodiment of the invention, the wearable may comprise the run time for the latch of 2-4, 2-5, 2-6, 2-7, 2-8, 3-4, 3-5, 3-6, 3-7, 3-8, 4-5, 4-6, 4-7, 4-8, etc., and/or any combination thereof of hours.

In an embodiment of the invention, the wearable may comprise a battery charge time of 5 hours or less, 0-30, 0-one hour, 0-2 hrs, 0-1.5 hrs, 0-2.5 hrs, 0-3 hrs, 0-3.5 hrs, 0-4 hrs, 0-4.5 hrs, 0-5 hrs, 1 hr, 2 hrs, 3 hrs, 4 hrs, 5 hrs, and/or any combination thereof.

In an embodiment of the invention, the wearable charging may be via USB/AC charger, solar, wireless, and/or any combination thereof.

In an embodiment of the invention, the wearable may be lightweight, ranging from 0.5-10, 1-10, 1.5-10, 2-10, 2.5-10, 3-10, 3.5-10, 4-10, 4.5-10, 5-10, 5.5-10, 6-10, 6.5-10, 7-10, 7.5-10, 8-10, 8.5-10, 9-10, 9.5-10, 0.5-10, 1-10, 1.5-8, 2-8, 2.5-8, 3-8, 3.5-8, 4-8, 4.5-8, 5-8, 5.5-8, 6-8, 6.5-8, 7-8, 7.5-8 oz, and/or any combination thereof.

In an embodiment of the invention, the wearable may be water-resistant, water-proof, or any combination thereof.

In an embodiment of the invention, color-coded LED tactile may switch for operation and functional use.

In an embodiment of the invention, the wearable may be strapped onto any two-strap backpack.

In an embodiment of the invention, no matter what time of the day, a user may know exactly where to press the button. The illumination levels of the surrounding maybe 0, 1, 2, 3, 4, 5, 6, 7, 8, 9, 10, 11, 12, 13, 14, 15, 16, 17, 18, 19, 20, 25, 30, 40, 45, 50 percent and/or any combination thereof of a sunny daylight illumination.

In an embodiment of the invention, the wearable may have a go-pro camera mount.

In an embodiment of the invention, the wearable may be made of customizable fabrics such as Hi-Vis Safety Yellow and Safety Orange, Camouflage, Coast Guard Red, Army Green, ANSI approved/military-grade fabrics, and/or any combination thereof.

In an embodiment of the invention, the LEDs, electrical lights streaks of one or more colors, LED bulbs, flashlights, a lantern, etc., and any combination thereof may form an illuminable network.

In an embodiment of the invention, the LEDs may be hidden underneath sewable transparent clear, semi-transparent, semi-opaque, tinted vinyl fabric, etc., and/or any combination thereof.

In an embodiment of the invention, the wearable(s) communication may be wired.

In an embodiment of the invention, the wearable(s) communication may be wireless.

In an embodiment of the invention, the wearable(s) communication may be wired to a controller.

In an invention of the invention, the communication and/or guidance system may have a command unit configured to instruct the wearable and/or non-wearables. The command unit may instruct the wearable/non-wearables to indicate a turn, stop, slow, accelerate, etc., signals via audio, tactile, the visual such as illuminations patterns, brightness level, intensity, strobing, changes in color, vibration, sound, etc., and/or any combination thereof.

In an embodiment of the invention, the command unit communication may be wireless to a controller.

In an embodiment of the invention, command unit communication may be via touch-sensitive technology.

In an embodiment of the invention, command unit communication may be via voice command technology.

In an embodiment of the invention, the command unit communication may be via the cellular phone, wherein the wearable may be integrated with a smartphone.

In an embodiment of the invention, the command communication may be via wired, wireless, remote control and/or any combination thereof.

In an embodiment of the invention, the wearable(s) communication may be wireless to a controller.

In an embodiment of the invention, wearable(s) communication may be via touch-sensitive technology.

In an embodiment of the invention, wearable(s) communication may be via voice command technology.

In an embodiment of the invention, the wearable(s) communication may be via the cellular phone, wherein the wearable may be integrated with a smartphone.

In an embodiment of the invention, the wearable(s) communication may be via wired, wireless, remote control and/or any combination thereof.

In an embodiment of the invention, the wearable(s) batteries may be recharged via wired, wireless, solar, and/or any combination thereof.

The wearable(s) may contain micro-GPS, GPS/SOS, or another tracking device in an embodiment of the invention. The tracking device may be tracked via micro-GPS, GPS, sound, light signals, and/or a combination thereof.

In an embodiment of the invention, the wearable(s) may be the weather-, water-, temperature-, fire, smoke, smog, fog, bullet humidity-resistance, and/or any combination thereof.

In an embodiment of the invention, the non-wearable(s) may be humidity, weather-, water-, temperature-, fire, smoke, smog, fog, bullet humidity-proof, and/or any combination thereof.

In an embodiment of the invention, the non-wearable(s) may be attachable, detachable, detachably-attached, and/or any combination thereof to a bullet-resistant, proof, and/or both wearable.

In an embodiment of the invention, the wearable(s) may contain one or more of a speaker, microphone, the cellular phone, the camera, electrical lights streaks of one or more colors, LED bulbs, flashlight, a lantern, vibrating modules, sound generation device, vehicles, recharging ports, recharging devices, etc.

In an embodiment of the invention, the camera can rotate from 0-360, e.g., 0-45, 0-90, 0-135, 0-180, 0-225, 0-280, 0-360 and/or any combination thereof,

In an embodiment of the invention, camarea may be extended from 0-5 feet, e.g., 0-1, 0-2, 0-3, 0-4, 0-5 feet and/or any combination thereof.

In an embodiment of the invention, the wearable(s) may contain various strobe light modes, various light color modes, and/or variable light brightness, and/or any combination of these settings that are used for safety.

In an embodiment of the invention, the wearable(s) may comprise of electronic, electrical, computerized, smart, etc. such as a speaker, microphone, the cellular phone, the camera, electrical lights streaks of one or more colors, LED bulbs, flashlight, a lantern, USB port, micro-USB port, vibrating modules, sound generation device, vehicles, recharging ports, and/or any combination thereof.

In an embodiment of the invention, the recharging devices may be made of and/or covered with weather-resistant and/or weather-proof materials.

In an embodiment of the invention, the wearable(s) may comprise various light-dimmer settings, variable light intensity settings, and/or any combination thereof that are used for safety.

In an embodiment of the invention, the wearable(s) may have one or more micro-USB and/or a USB port.

In an embodiment of the invention, the wearable(s) may have one or more kill switches to conserve battery charge. The kill switch(es) may completely turn off the apparatus such that no energy leaks during off or rest mode.

In an embodiment of the invention, the wearable(s) may be integrated with an app/APP. The app/APP user may remotely measure, maintain, read, alter, control, and/or any combination thereof one or more functions of the wearable.

The wearable(s) may be sewable, transparent, plastic, synthetic, non-synthetic, weather-resistance, weather-proof fabric, and/or any combination thereof in an embodiment of the invention.

In an embodiment of the invention, the wearable(s) may be adjustable via the use of straps, Velcro, stretchable, elastics, buckles, buttons, etc. This adjustability may add usability to the wearables by making the wearables more comfortable and adjustable in sizes.

In an embodiment of the invention, the wearable(s) may comprise the lightest, smallest, and/or any combination of technology devices, locations, materials, etc., for the wearer's best comfort.

In an embodiment of the invention, the wearable(s) may comprise the heaviest technology devices or material in one or more places for the wearer's proper balance and comfort.

A method of manufacturing the wearable may include backing synthetic or non-synthetic materials such as but not limited to cotton, silk, wool, linen, nylon, spandex, rayon, polyester, acrylic, natural leather, artificial leather, Hi-Vis Safety Yellow and Safety Orange, Camouflage, Coast Guard Red, Army Green, ANSI approved/military-grade fabrics, and/or any combination thereof. Electronics may be attached to these backing materials via a variety of methods such as, but not limited to, adhesive, non-adhesives, sewing, non-sewing, snap-on, glue, zippers, etc., and/or any combination thereof. The electronics may be then covered with transparent, translucent, or opaque materials depending upon visibility requirements. The backing materials and electronic material covering materials may be weather-resistant or -proof or they may be covered with weather-resistant or -proof material, or any combination thereof. Machine, equipment, devices, etc., in this manufacturing may be unique and novel for the purposes of manufacturing these wearables and/or non-wearables.

The method of use, wherein the wearable(s) may be integrated with a command unit configured to instruct the wearable to operate and perform functioning via an app/APP and/or without the APP. The app user may utilize the app to be remotely measuring, maintaining, reading, altering, controlling, and/or any combination thereof one or more functioning of the wearable.

The method of use, wherein the wearable(s) may be integrated with an app/APP. The app user may utilize the app to be remotely measuring, maintaining, reading, altering, controlling, and/or any combination thereof one or more functioning of the wearable.

The patch containing the electronic devices may be balanced and comfortable for the user. The patch may include a variety of wired, wireless, or both devices. The patch may contain electronic, micro-electronic, electrical, computerized, smart, wired, wireless communication, etc., and/or any combination thereof such as a speaker, microphone, the cellular phone, the camera, electrical lights, LED bulbs, flashlight, a lantern, USB port, micro-USB port, vibrating modules, sound generation device, vehicles, recharging ports, or any combination thereof. The recharging devices may be made of and/or covered with weather-resistant and/or weather-proof materials. The light and vibrating devices and components (electrical, electronics, microelectronics, computer, and others) may be present in or on one or more strips. The child, animal (dog, cat, etc.) may or cannot have a leash.

The communication may be at least uni-, bi-directional, i.e., from the user one user two and vice versa. However, communication may be multi-directional when communication may be between several users.

The user may communicate with the users via a variety of methods (including the command unit) and apparatus; he may talk over the speaker system, which may be located for the best hearing and comfort of the users. The device may be very lightweight for comfort and without hindering the user's movement.

The communication and guidance maybe by using the vibrating modules present at various locations on the wearables. The user may be taught the meaning of each vibration with various strobing, intensity, locations, and/or any combination thereof. Hence, they may use lighting, vibration, voice, etc., to communicate and guide others. More than one but less than 20 vibrating modules may be placed on the wearable device, and each device may have one or more (but less than 20) strobing and intensity of the vibration. Each setting of the vibration may be taught to indicate a specific command such as the vibration of the left module signals “turn left” or vibration of the right module signals “turn right” or strobing vibration of the module signals “increased heart rate of the user,” etc. The vibration intensity may be gentle such that it causes no pain, discomfort, harm, etc., and any combination thereof to the user.

The kill switch may turn the system completely or almost completely off by a variety of methods such as using the command unit and/or directly turning off a switch, by touch-sensitive, voice command turn-off systems, and/or any combination thereof. This kill switch system may ensure the most efficient use of battery and extended battery life for emergencies.

In an embodiment of the invention, the non-wearable(s) communication may be wired.

In an embodiment of the invention, the non-wearable(s) communication may be wireless.

In an embodiment of the invention, the non-wearable(s) communication may be wired to a controller.

In an embodiment of the invention, the non-wearable(s) communication may be wireless to a controller.

In an embodiment of the invention, the non-wearable(s) communication may be via touch-sensitive technology.

In an embodiment of the invention, the non-wearable(s) communication may be via voice command technology.

In an embodiment of the invention, the non-wearable(s) communication may be via the cellular phone, wherein the non-wearable may be integrated with a smartphone.

In an embodiment of the invention, the non-wearable(s) communication may be via a wired, wireless, or both remote-control.

In an embodiment of the invention, the non-wearable(s) batteries may be recharged via wired, wireless, solar, or any combination thereof.

In an embodiment of the invention, the non-wearable(s) may contain micro-GPS/SOS or another tracking device. The tracking device may be tracked via micro-GPS/SOS, sound (audio), light (visual) signals, etc., and/or any combination thereof.

In an embodiment of the invention, the non-wearable(s) may be the weather-, water-, temperature-, humidity-, fire-, smoke-, smog-, fog-, bullet-resistance, and/or any combination thereof.

In an embodiment of the invention, the non-wearable(s) may be humidity-, fire-, smoke-, smog-, fog-, bullet weather-, water-, temperature-, humidity-proof, and/or any combination thereof.

In an embodiment of the invention, the non-wearable(s) may be attachable, detachable, or both to a bullet-resistant, proof, or both wearable.

In an embodiment of the invention, the non-wearable(s) may contain one or more of a speaker, microphone, the cellular phone, the camera, electrical lights streaks of one or more colors, LED bulbs, flashlight, lantern, vibrating modules, sound generating devices, recharging ports, vehicles, etc., and/or any combination thereof.

In an embodiment of the invention, the camera may rotate from 0-360, e.g., 0-45, 0-90, 0-135, 0-180, 0-225, 0-280, 0-360, and/or any combination thereof.

In an embodiment of the invention, the camera may be extended from 0-5 feet, e.g., 0-1, 0-2, 0-3, 0-4, 0-5 feet, and/or any combination thereof.

In an embodiment of the invention, the non-wearable(s) may be one or more micro-USB, a USB port(s), and both.

In an embodiment of the invention, the non-wearable(s) may contain one or more strobe light modes, light color modes, light brightness modes, and/or any combination.

In an embodiment of the invention, the non-wearable(s) may have one or more kill switches to conserve battery charge. The kill switch may turn off the apparatus such that no energy leaks during off or rest mode.

In an embodiment of the invention, the non-wearable(s) may comprise of electronic, electrical, computerized, communication via wired and/or wireless, smart, etc. such as a speaker, microphone, the cellular phone, the camera, electrical lights streaks of one or more colors, LED bulbs, flashlight, a lantern, USB port, micro-USB port, vibrating modules, sound generation device, vehicles, recharging ports, etc., or any combination thereof. The recharging devices are made of and/or covered with weather-resistant and/or weather-proof materials.

In an embodiment of the invention, the non-wearable(s) may be integrated with an app/APP.

The communication and guidance system may provide for the integration of wearable devices and non-wearable devices. The wearable devices may be for one or more humans. One or more animals may wear the wearable in combination with one or more humans. They may communicate and guide with other wearable and/or non-wearable devices and systems.

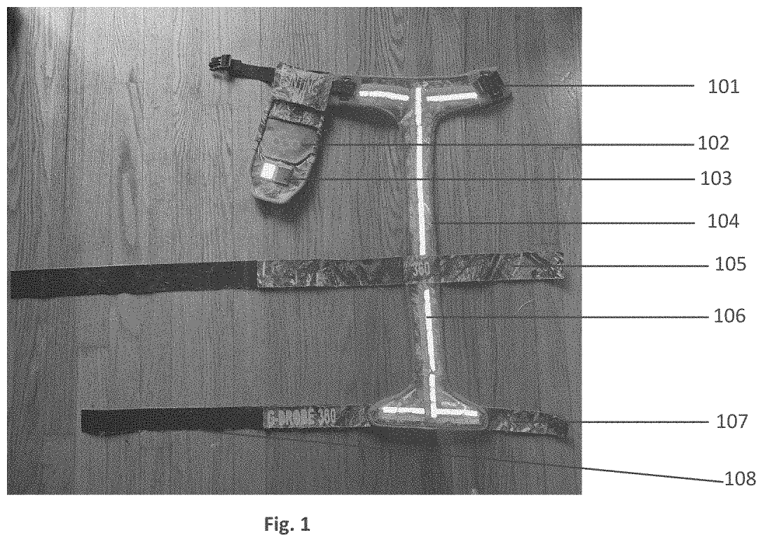

FIG. 1: An example of an animal self-illuminating wearable device.

Shown is a wearable device containing four linear strips 101, 104, 105, 107. The first strip 104 is perpendicular (at 90 degrees angle) to the other three strips, the second 101 and the fourth perpendicular strips 107 are attached to the two terminal ends of the first strip 104, the third strip is non-terminal 105, wherein a patch or pouch 102 containing electronics. The electronics and other equipment, apparatus, or devices are contained in a pouch 102 and have two lights (white and red herein) 103. As shown in this figure, the terminal ends of the strips second 101, third 105, and fourth 107 may attach via Velcro, clips, buckle, etc., to form a loop 108. Strip 101 contains one or more light streaks 106. Other strips containing light can be added that are parallel to strip 104 and connect strips 101, 105, and 107 such that additional light can be present on both sides of an animal such as a dog or a cat.

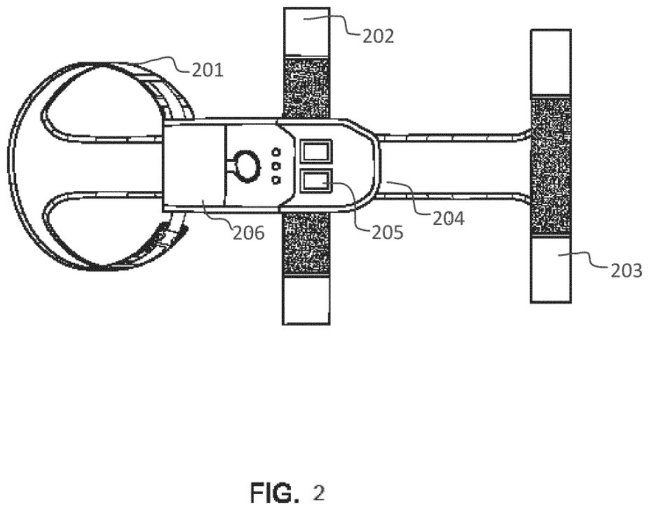

FIG. 2: An example of an animal self-illuminating wearable device.

This figure shows a wearable device pouch 206 containing four linear strips 201-204. The first strip is perpendicular 204 to the other three strips. The second 201 and the fourth perpendicular strip 203 are attached to the two terminal ends of the first strip 204. The third strip is non-terminal 202, wherein a patch or pouch 206 having electronics and is weather-resistant. The pouch connects the first 204, second 201, and third strips 203 and sits at the most convenient and comfortable place on the dog's neck. This pouch can be placed at other locations on the dog, such as below the dog's belly, neck, etc. Two light bulbs 205 direct the light to shine light into the sky, one light is white, and the other is red. These can be replaced with different light colors. The technologies may be apparatus, devices, smart devices, electrical equipment, microelectronics, electronics, computer, hardware, software, instruments, machinery, and equipment.

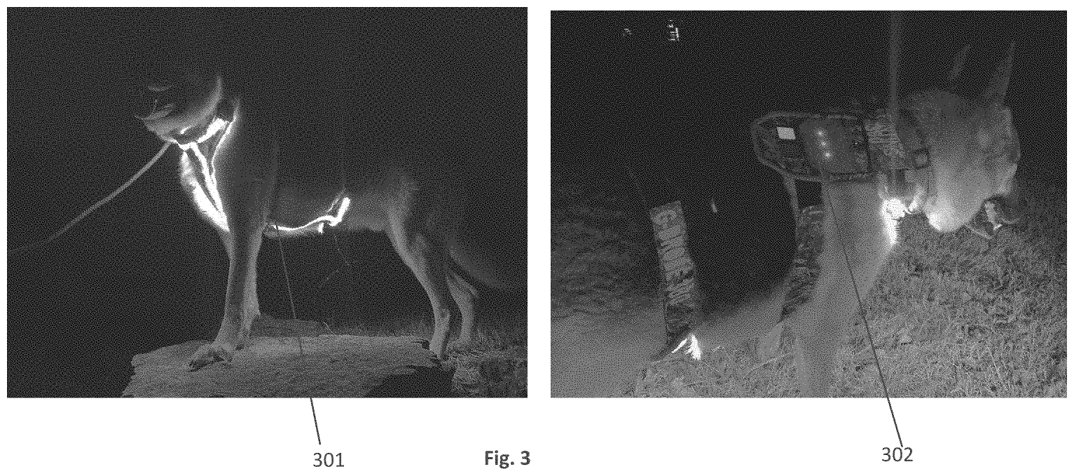

FIG. 3: An example of an animal self-illuminating wearable device worn by a dog.

Shown in this figure is the light streak at the bottom or belly of the dog 301. The intensity of the light streak makes grounds around the dog visible during darkness. This visible area can have a diameter of 5 to 50 feet. Herein the entire wearable and the electronic device pouch are very lightweight. The pouch is placed comfortably on the dog's neck 401. The pouch can also contain lights that can be white or colored 302. The weight of the pouch can be from 0.5 to 10 pounds. Technologies may be apparatus, devices, smart devices, electrical equipment, microelectronics, electronics, computer, hardware, software, instruments, machinery, and equipment.

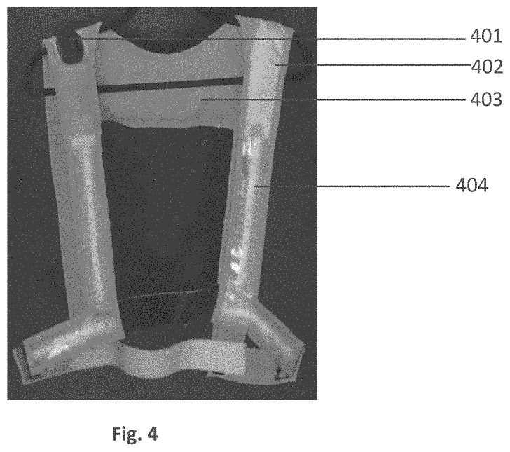

FIG. 4: An example of the self-illuminating wearable device for humans.

Shown in this figure is a human wearable with the same functions as the aforementioned dog wearable. This wearable can be worn over shoulders or can be attached to any sized backpack. Herein, microphone, speakers are present on the shoulder 401. The earpiece (speakers) and microphone that can be attached to the earpiece are not shown herein. Electronics, microelectronics, electricals, devices, rechargeable batteries, etc., are placed on the shoulder strap and back of the neck for comfort with optimum balance 402 and 403. The straps are adjustable for ease of wear. The weight of the electronics, microelectronics, electricals, devices, etc., can be from 0.5 to 10 pounds. One or more light streaks light the same as the aforementioned dog wearable are present in each strap 404. These lights can also be used as a turn signal function and have various strobe settings and brightness settings for safety utility. The fabric used for this wearable is a sewing machine compatible and transparent plastic fabric.

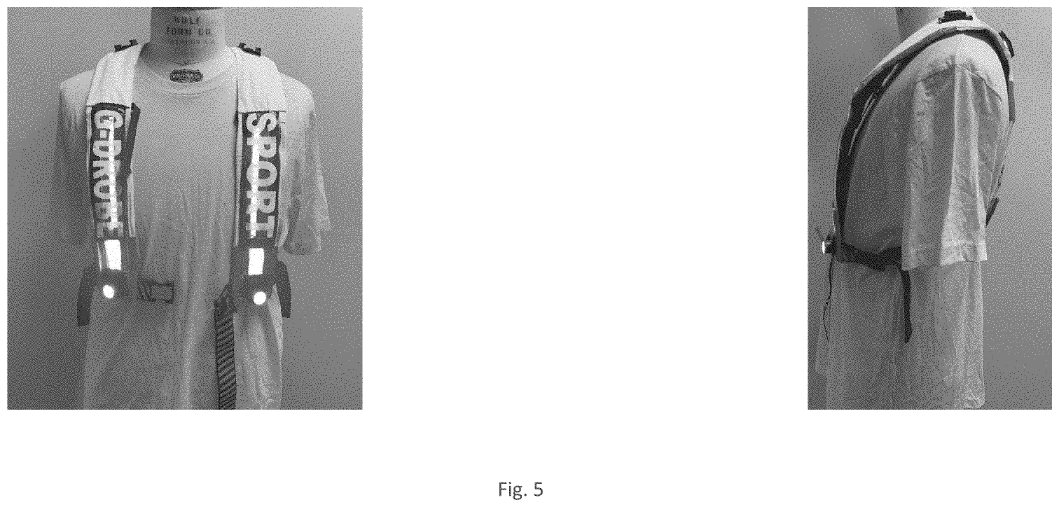

FIG. 5: An example of the self-illuminating wearable device for humans worn by a male.

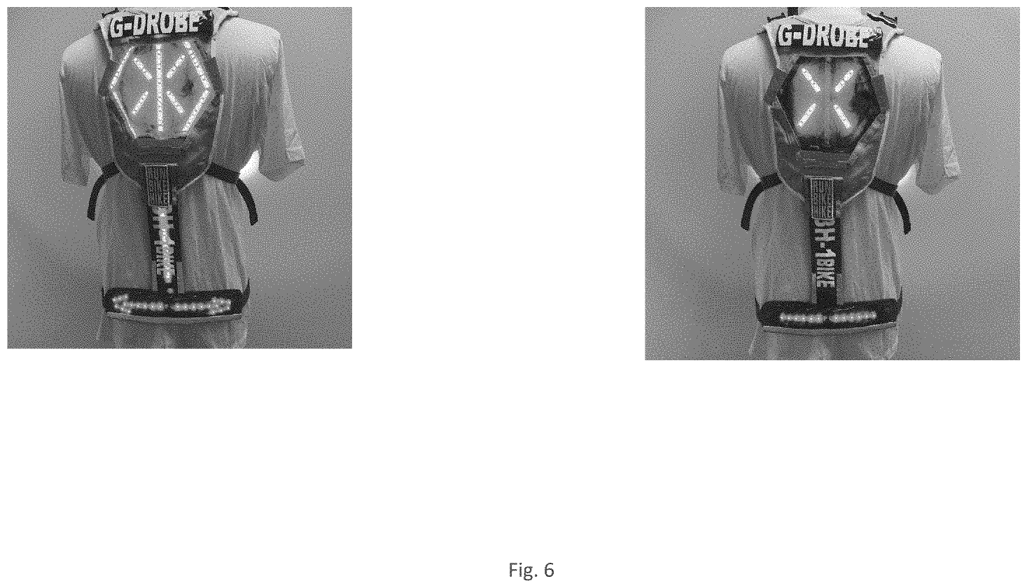

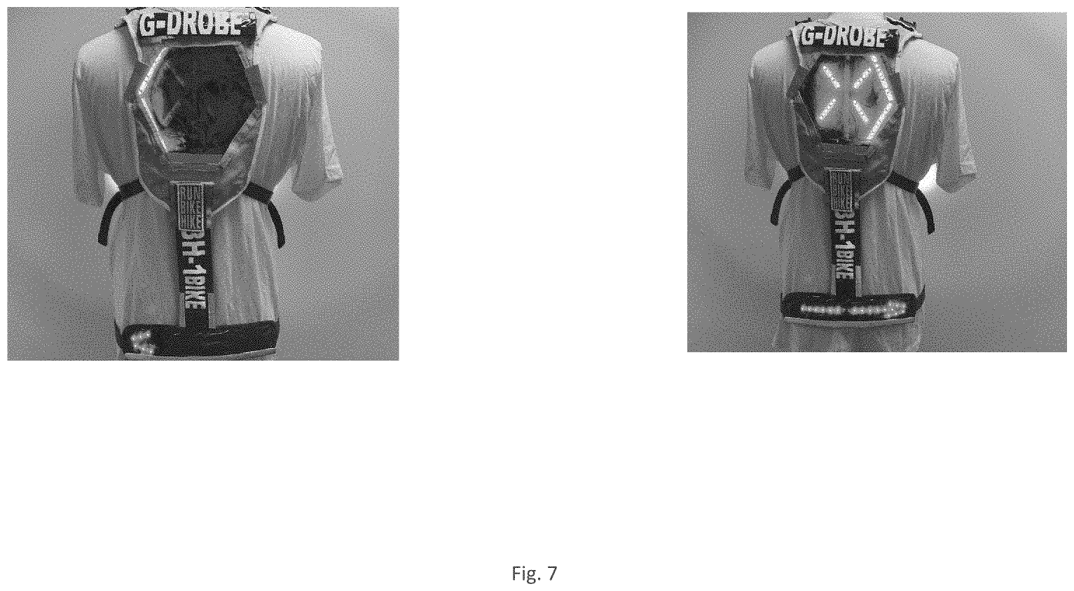

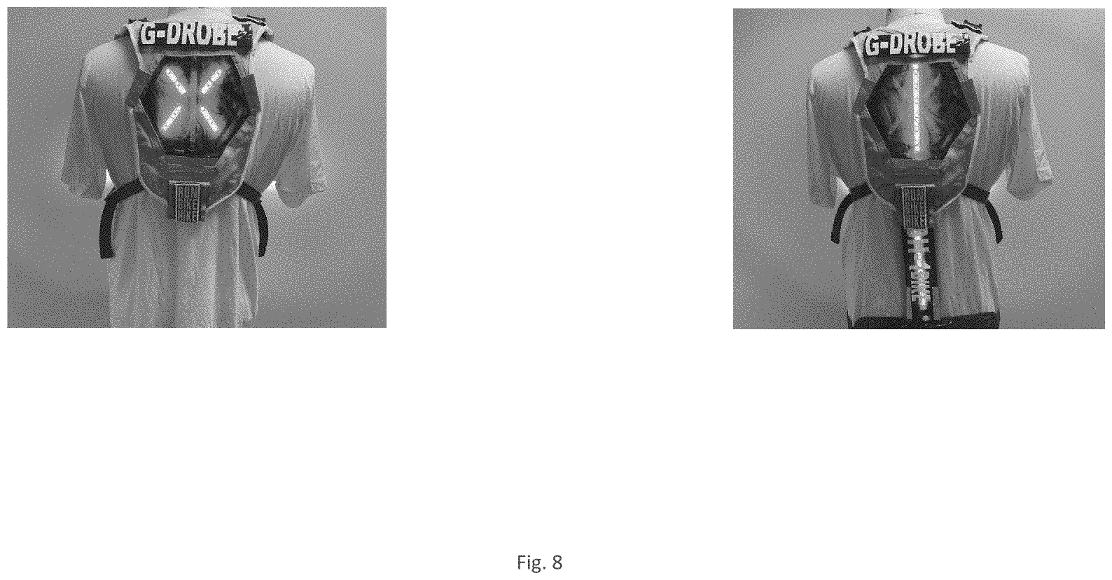

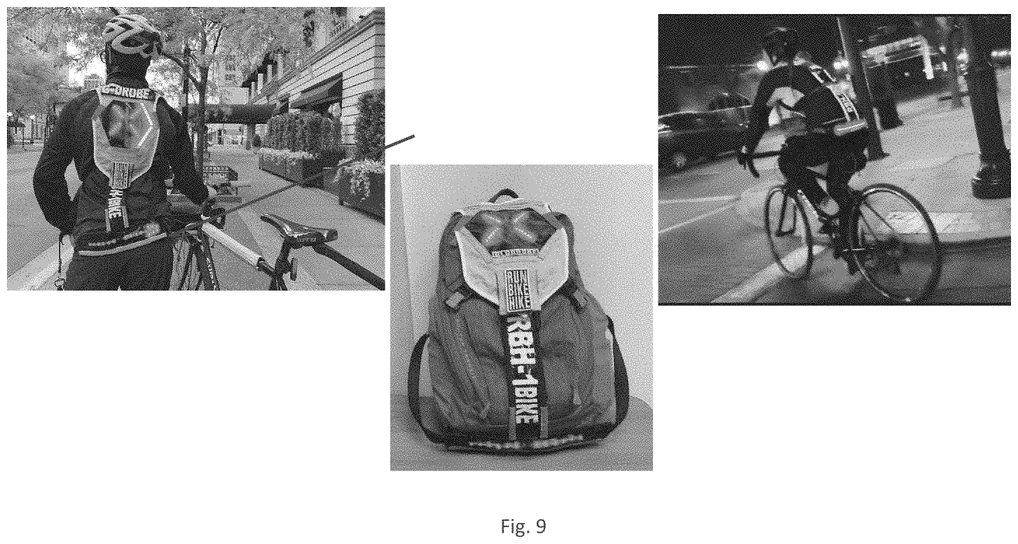

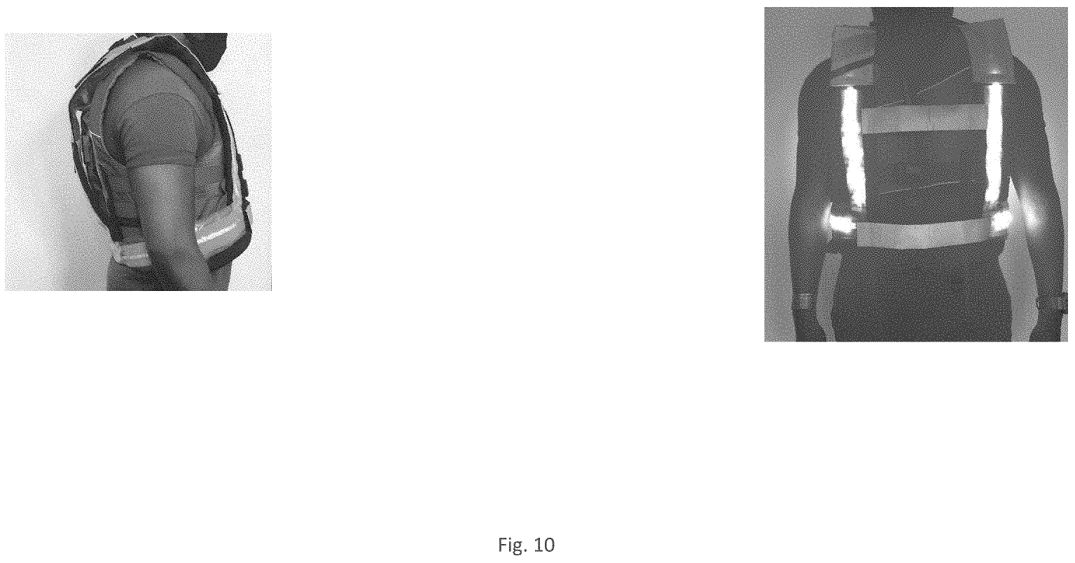

FIGS. 6-10: An example of the self-illuminating wearable device communication with other wearable users and wearable non-users.

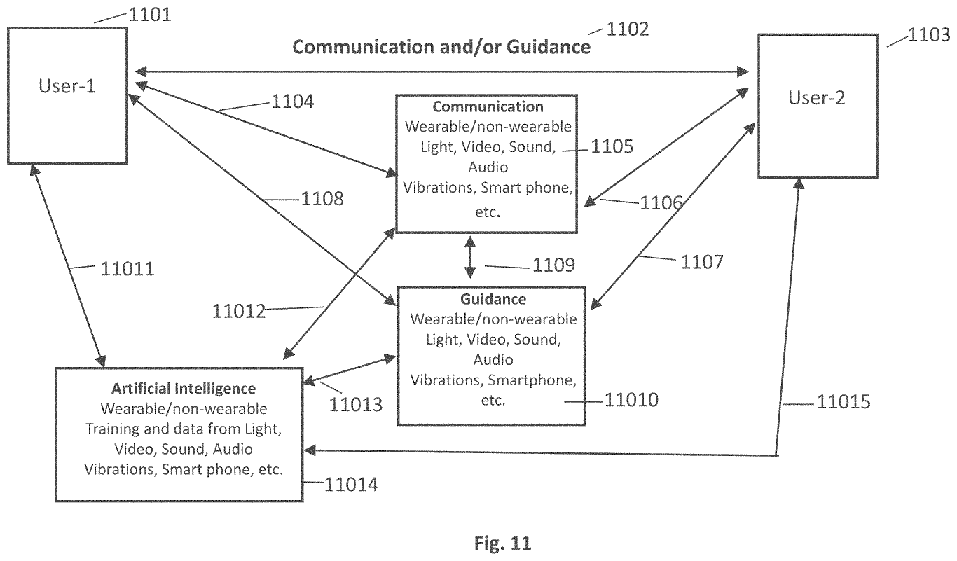

FIG. 11: Integration of wearables and non-wearables for humans and non-human animals.

Shown here is communication and guidance between two groups of users, wherein the first users 1, 1101, and the second user 2, 1103. The communication and guidance may be between these two users. The users may be humans, e.g., hunters and the other users may be animals, e.g., dogs, cats, etc. The communication and guidance may be direct without the use of any wearables or non-wearable 1102. Communication and guidance may be indirect via wearable and/or non-wearables of the invention 1104, 1105, 1106, 1108, 11010, 1107. Communication and guidance may be automatic via artificial intelligence 11011, 11014, 11015, 11012, 11013, or manual by the user 1104, 1105, 1106, 1108, 11010, 1107. The user's manual control or operation may supersede automatic control or operation via artificial intelligence 11011, 11014, 11015, 11012, 11013. Wearable and/or non-wearable may have one or more (at least one) devices, technologies, etc. connected such as speaker, microphone, the smart or cellular phone, the camera, video, electrical lights streaks of one or more colors, LED bulbs, flashlight, lantern, vibrating modules, sound generating devices, recharging ports, vehicles, vehicle parts (e.g., staring-wheel, handle-bar, brakes, lights, electronic systems, electrical systems, sensors, floor components car seat, powertrain and chassis, braking system, electrified powertrain components, engine components, engine cooling system, engine oil systems, headlights, bumper cover, car fender, radiator support, catalytic converter, car mirror, car hood, step bumper, lower control arm, tail light, window regulator, fuel pump replacement, car body and main part body components, including trim, bonnet/hood, bonnet/hood, bumper, unexposed bumper, exposed bumper, cowl screen; decklid, suspension and steering systems, transmission system, air conditioning system, bearings, hose, charging docks, etc.), 2-10, 2, 4, 6, 8, 10 wheeled vehicles, artificial intelligence hardware, software, training data, collected data, etc., or any combination thereof 1105, 11010. These electronics or devices may be used for communication alone and/or guidance. These wearable and/or non-wearable linked devices or technologies may be further connected or linked to an artificial module, which may include hardware, software, training data, collected data, speaker, microphone, the smart or cellular phone, the camera, video, electrical lights streaks of one or more colors, LED bulbs, flashlight, lantern, vibrating modules, sound generating devices, recharging ports, vehicles, vehicle parts (e.g., staring-wheel, handle-bar, brakes, lights, electronic systems, electrical systems, sensors, floor components car seat, powertrain and chassis, braking system, electrified powertrain components, engine components, engine cooling system, engine oil systems, headlights, bumper cover, car fender, radiator support, catalytic converter, car mirror, car hood, step bumper, lower control arm, tail light, window regulator, fuel pump replacement, car body and main part body components, including trim, bonnet/hood, bonnet/hood, bumper, unexposed bumper, exposed bumper, cowl screen; decklid, suspension and steering systems, transmission system, air conditioning system, bearings, hose, charging docks, etc.),

It is to be understood that the above description is intended to be illustrative, and not restrictive. For example, the above-described embodiments (and/or aspects thereof) may be used in combination with each other. In addition, many modifications may be made to adapt a particular situation, method, system device, or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claims.

What is claimed is:

1) A communication and guidance system comprising two or more self-illuminable wearables, a command unit, a modulation unit, wherein the command unit is configured to instruct the wearable, wherein the wearable comprises an energy source, illumination network, wherein at least one self-illuminable user is a human, the wearable covers at least 2.5% part of the human torso, and the wearable is configured to communicate with at least one another wearable user.

2) The illuminable wearable of claim 1, wherein the illumination can signal to turn left/right, slow, accelerate, stop; wherein the illumination network is configured to be wireless/Bluetooth.

3) The illuminable wearable of claim 1, comprises a dimmer switch with seven different levels of illumination brightness.

4) The illuminable wearable of claim 1, comprises up to ten different strobes settings.

5) The illuminable wearable of claim 1, the wearable comprises 3s lithium-ion batteries are strategically hidden inside the wearable located below the neck of the user to provide a balance in weight.

6) The illuminable wearable of claim 1, wherein the LED strips on the illuminating wearable comprise up to 50,000 hours of battery life.

7) The illuminable wearable of claim 1, wherein the wearable comprises interchangeable activity T-clip accessories.

8) The illuminable wearable of claim 1, wherein the wearable comprises of strobing with a run time of 8-16 hours for illumination.

9) The illuminable wearable of claim 1, wherein the wearable comprises the run time for the latch of 4-6 hours.

10) The illuminable wearable of claim 1, wherein the wearable comprises a battery charge time of at least 2 hours.

11) The illuminable wearable of claim 1, wherein the wearable charging is via USB/AC charger, solar, wireless, or any combination thereof.

12) The illuminable wearable of claim 1, wherein the wearable is lightweight, ranging from 6-8 oz (ounces).

13) The illuminable wearable of claim 1, wherein the wearable is water-resistant, water-proof, or any combination thereof.

14) The illuminable wearable of claim 1, wherein color-coded LED tactile switches for operation and functional use.

15) The illuminable wearable of claim 1, wherein the wearable can be strapped onto any two-strap backpack.

16) The illuminable wearable of claim 1, a user knows exactly where to press the button during all illumination levels from 0-100%.

17) The illuminable wearable of claim 1, wherein the wearable has a go-pro camera mount.

18) The illuminable wearable of claim 1, wherein the wearable is made of customizable fabrics such as Hi-Vis Safety Yellow and Safety Orange, Camouflage, Coast Guard Red, Army Green, ANSI approved/military-grade fabrics, or any combination thereof.

19) The illuminable wearable of claim 1, wherein the LEDs are hidden underneath sewable transparent clear and tinted vinyl fabric.
